(19) United States
(12) Patent Application Publication
(10) Pub. No.: US 2017/0275738 A1
(43) Pub. Date: Sep. 28, 2017

(54) ALUMINUM ALLOY MATERIAL AND BONDED OBJECT, AND AUTOMOTIVE MEMBER

(71) Applicant: KABUSHIKI KAISHA KOBE SEIKO SHO (KOBE STEEL, LTD.), Kobe-shi (JP)

(72) Inventors: Takahiro OZAWA, Hyogo (JP); Satoru TAKADA, Hyogo (JP); Akihiko TATSUMI, Hyogo (JP)

(73) Assignee: KABUSHIKI KAISHA KOBE SEIKO SHO (KOBE STEEL, LTD.), Kobe-shi (JP)

(21) Appl. No.: 15/505,971

(22) PCT Filed: Aug. 27, 2015
(86) PCT No.: PCT/JP2015/074300

§ 371 Date: Feb. 23, 2017

(30) Foreign Application Priority Data
Aug. 27, 2014 (JP) 2014-173279

(51) Int. Cl. C22C 21/08; G01N 23/227; B32B 7/12; B32B 15/20; C22F 1/05; B32B 15/04

(52) U.S. Cl. CPC C22C 21/08; C22F 1/05; B32B 15/043; B32B 7/12; B32B 15/20; G01N 23/2273; B32B 2605/00

(57) ABSTRACT

An Al—Mg—Si aluminum alloy material includes Sn. An oxide film formed on a surface of the aluminum alloy material is analyzed by a semi-quantitative analysis by X-ray photoelectron spectroscopy. A ratio of the number of Sn atoms to the number of Mg atoms in the oxide film is 0.001 to 3 on average. A ratio of the total number of atoms of Sn and Mg to the number of oxygen atoms is 0.001 to 0.2 on average.

### TECHNICAL FIELD

The present invention relates to an Al—Mg—Si aluminum alloy material which is excellent especially in bonding durability, and a joined body as well as an automotive member. The aluminum alloy material as referred to in the present invention means a rolled sheet, such as a hot rolled sheet, a cold rolled sheet, etc., or an extruded material resulting from hot extrusion, a forged material resulting from hot forging, and so on. In addition, in the following description, the term “aluminum” is also referred to as “Al”.

### BACKGROUND ART

In recent years, from the consideration to global environment, social needs in weight reduction to vehicles such as automobiles are increasing. To respond to the needs, a lightweight aluminum alloy material having excellent formability and baking hardenability is increasingly used as a material of large-sized body panel structures (outer panel, inner panel and the like) for automobiles, a reinforced member and the like in place of a steel material such as a steel sheet.

For the purpose of thickness reduction, an Al—Mg—Si aluminum alloy material of AA or JIS 6000 series (hereinafter simply referred to as 6000 series) is used as a high strength aluminum alloy in automobile members such as those panel structures or reinforcing members.

The 6000 series aluminum alloy material has the advantage of having excellent BH responses, but has the problem that the aluminum alloy material has room temperature aging property, and formability into a panel, particularly bending workability, is deteriorated by the fact that age hardening occurs by maintaining at room temperature after a solution/quenching treatment, thereby increasing strength. Furthermore, in the case where the room temperature aging is large, the following problems occur: BH responses are deteriorated, and yield strength is not improved up to strength required as a panel depending on heating during an artificial aging (hardening) treatment at relatively low temperature such as a paint baking treatment of a panel after forming.

As one of metallurgical measures to the problem, a method of positively adding Sn to a 6000 series aluminum alloy sheet, thereby improving suppression of room temperature aging and improvement of BH responses is proposed. For example, Patent Document 1 proposes a method of adding an appropriate amount of Sn and then performing pre-aging after a solution treatment, thereby having both of suppression of room temperature aging and BH responses. Furthermore, Patent Document 2 proposes a method of adding Sn and Cu that improves formability, thereby improving formability, a baking property and corrosion resistance.

### PRIOR ART DOCUMENTS

### Patent Document

Patent Document 1: JP H09-249950 A

Patent Document 2: JP H10-226894 A

### SUMMARY OF INVENTION

### Technical Problem

However, these conventional Al—Mg—Si aluminum alloy materials to which Sn has been positively added involve a problem that bonding durability should be further improved.

That is, as a method of joining the Al—Mg—Si aluminum alloy material having Sn added thereto to other member as the automotive member, in addition to mechanical joining, welding and joining with a bonding agent have been selectively adopted or used in combination. In contrast thereto, in recent years, in order to achieve improvement of joining strength in the case of using the bonding agent or simplicity of execution, the bonding agent has been frequently used for joining of a lot of automotive members. As compared with the mechanical joining or joining in which welding is executed at points or lines, in the case of bonding with a bonding agent, joining strength is higher because the joining is executed over an entire surface, so that the case of bonding with a bonding agent is advantageous from the standpoints of automotive collision safety and so on. In addition, for automotive materials for exterior use required to have beautiful view or appearance, such as outer panels, etc., the mechanical joining or welding or the like is not applicable, but the joining is limited to joining with a bonding agent.

However, in aluminum alloy-made automotive members joined with a bonding agent, the following problem was involved: in view of invasion of moisture, oxygen, a chloride ion, and so on into a joined part during the use, an interface between a bonding layer and an aluminum alloy sheet is gradually deteriorated, interfacial peeling is generated, and bonding strength is deteriorated. In particular, in view of penetration of a seawater-derived airborne salt or a salt contained in an antifreeze of roads, etc., deterioration of a joined portion (bonded portion) is accelerated, resulting in deterioration of bonding durability.

As a method of improving such bonding durability, a method of removing a weak oxide film that is liable to cause interfacial peeling on a surface of an aluminum alloy sheet in advance by means of acid cleaning prior to application of a bonding agent, or the like is generally used. However, the effect due to such a method is low for Al—Mg—Si aluminum alloy materials having Sn added thereto. In addition, a method of anodizing a surface of the aluminum alloy sheet to give to an oxide film a surface structure so as to bring about an anchor effect; and a method of treating a surface of an aluminum alloy sheet with warm water to adjust the Mg amount and OH amount of an oxide film that is liable to cause interfacial peeling are also generally used. However, the effect obtained by those methods is also low for Al—Mg—Si aluminum alloy materials having Sn added thereto.

In consequence, in order to apply an Al—Mg—Si aluminum alloy material having Sn added thereto to an automotive member through joining with a bonding agent, there was a serious problem in improving its bonding durability.

In order to solve the foregoing problems, the present invention has been made, and an object thereof is to provide a Sn-added Al—Mg—Si aluminum alloy material with improved bonding durability as an automotive member, a joined body using this aluminum alloy material, and an automotive member including this joined body.

### Technical Solution

The summary of the present invention for an aluminum alloy material to achieve the object(s) is as follows. An Al—Mg—Si aluminum alloy material includes Sn, and on semi-quantitative analysis of an oxide film formed on a surface of the aluminum alloy material by X-ray photoelectron spectroscopy, a ratio (Sn/Mg) of the number of atoms of Sn to that of Mg in the oxide film is 0.001 to 3 on average, and a ratio {(Sn+Mg)/O} of the total number of atoms of Sn and Mg to the number of atoms of oxygen is 0.001 to 0.2 on average.

The summary of the present invention for a joined body to achieve the object(s) is as follows. A joined body includes the aluminum alloy materials, and the aluminum alloy materials are joined to each other through a bonding layer such that respective oxide films face each other.

The summary of the present invention for an automotive member to achieve the object(s) is as follows. An automotive member includes the aluminum alloy material or the joined body.

### Advantageous Effects of Invention

The present inventors have found that in a surface oxide film of a Sn-containing Al—Mg—Si aluminum alloy sheet, by concentrating Sn through diffusion of Sn from a matrix or addition of Sn from the outside, the bonding durability is improved. Meanwhile, Mg that is a main component of the Al—Mg—Si aluminum alloy sheet is diffused from the matrix into the surface oxide film and concentrated, resulting in deterioration of the bonding durability.

For this reason, in the present invention, not only a specific amount of Sn is contained in the surface oxide film of the Sn-containing Al—Mg—Si aluminum alloy sheet, but also the Mg content is regulated, thereby improving the bonding durability as an automotive member.

However, the existing state of Sn and Mg in such a surface oxide film varies with a thickness direction of the surface oxide film. As for the bonding durability of the bonding agent, the existing state of Sn and Mg in the surface oxide film in an extremely shallow portion, such as an outermost surface or surface layer part of the surface oxide film coming into contact with the bonding agent, etc., should be more relevant rather than that in a deep portion of the surface oxide film.

In consequence, a problem of the present invention resides in the existing state of Sn and Mg in the surface oxide film in an extremely shallow portion, such as an outermost surface or surface layer part of the surface oxide film coming into contact with the bonding agent, etc.

For this reason, in the present invention, a ratio (Sn/Mg) of the number of atoms of Sn to that of Mg in a surface oxide film, or a ratio {(Sn+Mg)/O} of the total number of atoms of Sn and Mg to the number of atoms of oxygen, which significantly influences the bonding durability of a bonding agent, through semi-quantitative analysis by X-ray photoelectron spectroscopy capable of analyzing the existing state of Sn and Mg in a surface oxide film in such an extremely shallow portion, is specified.

A composition of this surface oxide film in the present invention may be in a state after manufacture of an aluminum alloy material; however, taking into consideration any changes of the oxide film depending on a leave time at room temperature after the manufacture of the sheet, it is most preferred that when after forming into an automotive material, the members are joined to each other or the member is joined to other member with a bonding agent, the resulting composition of the surface oxide film has the above-described prescribed specified composition.

As a result, in accordance with the present invention, the bonding durability of a Sn-added Al—Mg—Si aluminum alloy material can be effectively improved, and the application of this aluminum alloy material to automotive materials and so on, in which the aluminum alloy material is joined to other member with a bonding agent, can be made possible or promoted.

### BRIEF DESCRIPTION OF DRAWING

FIG. 1 is an explanatory view showing an embodiment of a test of bonding durability in Examples.

### DESCRIPTION OF EMBODIMENTS

Embodiments of the present invention are hereunder specifically described for each requirement.

### (Chemical Component Composition)

So long as the Al—Mg—Si aluminum alloy material in the present invention contains Sn and has a composition that is satisfactory with required properties as an automotive member, composition ranges of 6000 series aluminum alloys in line with the JIS to AA standards are applicable. However, as automotive members, especially raw materials for panels, in the case where the aluminum alloy material is a cold rolled sheet, it is necessary to satisfy such required properties for automotive panels.

Specifically, as properties after T4 tempering, such as solution treatment, quenching treatment, etc., it is necessary to have a BH response (bake hardenability) such that on forming into an automotive panel, the 0.2% yield strength is decreased low as 110 MPa or less, whereby formability can be ensured, and after baking hardening as the subsequent automotive member, the 0.2% yield strength is increased high as 200 MPa or more. In consequence, it is preferred that the aluminum alloy is allowed to make this possible from the standpoint of composition. In addition, the automotive member is required to have, in addition to excellent formability and BH response, various properties, such as rigidity, weldability, corrosion resistance, etc., depending on use in application for a member, and hence, it is preferred that these requirements are also satisfied from the standpoint of composition. The term “Al—Mg—Si series” is also referred to as “6000 series”.

As for a preferred composition of the 6000 series aluminum alloy sheet satisfying the various properties required as the above-described automobile panel member, the composition contains, in mass %, Sn: 0.005 to 0.3% and contains, as main components in mass %, Mg: 0.2 to 2.0% and Si: 0.3 to 2.0%. The remainder may be Al and unavoidable impurities. Other elements than these Mg, Si, and Sn are impurities or elements which may be contained, and the content thereof is set to a content (permissible amount) of each element level in line with the AA to JIS standards. In addition, in this description, the percentage (mass %) on the basis of mass is same as percentage (weight %) on the basis of weight. In addition, with respect to the content of each chemical component, the term “X % or less (excluding 0%”) may be indicated as “more than 0% and X % or less”.

In the above-described 6000 series aluminum alloy composition, the content range and meaning, or permissible amount of each element is also hereunder described.

### Si: 0.3 to 2.0%

Si, along with Mg, is an indispensable element for forming an aged precipitate which contributes to the improvement of strength during an artificial aging treatment such as a baking treatment to exhibit age hardenability and providing strength (yield strength) required as an automobile panel. In a case where the amount of Si added is too small, the precipitation amount after the artificial aging becomes too small, and the increased rate of strength during baking becomes too low. On the other hand, in a case where the Si content is too large, a coarse precipitate, such as Fe as an impurity, etc., is formed, resulting in remarkable deterioration of formability, such as bendability, etc. Furthermore, in a case where the Si content is too large, not only strength just after the manufacturing of a sheet, but the aged amount at room temperature after manufacturing are increased, and strength before forming becomes too high. As a result, formability into a panel structure of automobile, particularly an automobile panel in which surface deflection becomes a problem, is deteriorated. In consequence, the Si content is preferably set to a range of 0.3 to 2.0%. The more preferred lower limit of the Si content is 0.4%, and the more preferred upper limit of the Si content is 1.6%.

In order to exhibit excellent age hardenability in a baking treatment at lower temperature for shorter period of time after forming into a panel, it is preferred to provide a 6000 series aluminum alloy composition in which Si/Mg is set to 1.0 or more in mass ratio and the content of Si with respect to Mg is more excessive than in a typically called excess-Si type.

### Mg: 0.2 to 2.0%

In addition to Si, Mg is an important element for the above-described cluster formation specified in the present invention and is an indispensable element for forming an aged precipitate which contributes to the improvement of strength during the artificial aging treatment such as a baking treatment to exhibit the age hardenability and providing yield strength required as an automobile panel. In a case where the Mg content is too small, the precipitation amount after the artificial aging becomes too small, and strength after baking becomes too low. On the other hand, in a case where the Mg content is too large, a coarse precipitate, such as Fe as an impurity, etc., is formed, resulting in remarkable deterioration of formability, such as bendability, etc. In addition, in a case where the Mg content is too large, not only the strength immediately after manufacturing but also the aging amount at room temperature after manufacturing become high, and the strength before forming becomes too high, so that formability into a panel structure of automobile, especially an automotive panel in which surface distortion is of a problem, or the like, is deteriorated. In consequence, the Mg content is preferably set to a range of 0.2 to 2.0%. The more preferred lower limit of the Mg content is 0.3%, and the more preferred upper limit of the Mg content is 1.6%.

### Sn: 0.005 to 0.3%

In a case where Sn is contained in an amount of 0.005 to 0.3% in the aluminum alloy material, room-temperature aging of a sheet after manufacturing is suppressed, whereby the 0.2% yield strength on forming into an automotive member can be decreased low as 110 MPa or less, and formability into a panel structure of automobile, especially an automotive panel in which surface distortion is of a problem or the like, can be improved. In addition, the 0.2% yield strength after baking hardening can be increased from the standpoint of composition. In consequence, the Sn content is preferably set to a range of 0.005 to 0.3%. The more preferred lower limit of the Sn content is 0.010%, and the still more preferred lower limit of the Sn content is 0.020%; and the more preferred upper limit of the Sn content is 0.2%.

Sn captures (catches, traps) atomic vacancy at room temperature to suppress diffusion of Mg and Si at room temperature, and suppresses strength increase at room temperature. Sn releases the captured vacancy during the artificial aging treatment such as a baking treatment of a panel after forming, and therefore rather accelerates the diffusion of Mg and Si and increases BH responses. In a case where the Sn content is less than 0.005%, the vacancies cannot be thoroughly trapped, so that the effect cannot be exhibited. On the other hand, in a case where the Sn content is more than 0.3%, Sn segregates on the grain boundary, resulting in easily causing intergranular cracking.

With respect to other elements, from the standpoint of resource recycle, in the case of using not only high purity Al ground metal, but a 6000 series alloy containing large amounts of elements other than Mg and Si as additional elements (alloy elements), other aluminum alloy scraps, low purity Al ground metal and the like as melting materials of an alloy, the following elements are inevitably mixed in an substantial amount. In a case where those elements are positively reduced, refining itself increases costs. Therefore, it is necessary to admit to contain those to some extent.

In consequence, in the present invention, it is permitted that the following elements are each contained in a range of the upper limit or less in line with the AA to JIS standards as prescribed below, or the like. More specifically, the aluminum alloy sheet may further contain one kind or two or more kinds selected from the group consisting of Fe: 1.0% or less (not including 0%), Mn: 1.0% or less (not including 0%), Cr: 0.3% or less (not including 0%), Zr: 0.3% or less (not including 0%), V: 0.3% or less (not including 0%), Ti: 0.1% or less (not including 0%), Cu: 1.0% or less (not including 0%), Ag: 0.2% or less (not including 0%), and Zn: 1.0% or less (not including 0%) in each of those ranges, in addition to the basic composition mentioned above.

### (Aluminum Alloy Material)

The aluminum alloy material as referred to in the present invention refers to a thin cold rolled sheet of 2 mm or less for panels as an automotive member, such as an outer or inner panel, etc. In addition, the aluminum alloy material in the present invention refers to a thick hot rolled sheet or hot extruded material exceeding 2 mm for structural materials, such as a pillar, etc., or reinforced materials, such as a panel, a bumper, a door, etc., or to a hot forged material for underbody parts, such as an arm, etc.

Such aluminum alloy materials are commonly manufactured by a usual method or a known method in terms of a manufacturing process per se. That is, an aluminum alloy slab having the above-described 6000 series component composition is cast and then subjected to harmonizing heat treatment, followed by hot working (e.g., rolling, extrusion, or forging), and thereafter, cold working, such as cold rolling, etc., is applied, as the need arises, thereby forming in a shape having a predetermined thickness. Then, tempering treatment (T4 to T6) to which solution treatment and quenching treatment, and further pre-aging treatment, reheating treatment, and the like have been added, as the need arises, is applied to manufacture the aluminum alloy material. The diffusion of Sn or Mg from the matrix into the surface oxide film and the concentration are promoted by such heat treatment on the tempering treatment.

### (Surface Treatment)

The treatment, such as alkali degreasing treatment, acid cleaning treatment with a liquid containing sulfuric acid, desmutting treatment with a liquid containing nitric acid, surface treatment for corrosion protection, etc., is selected and applied to the aluminum alloy material after the tempering treatment, in particular a cold rolled sheet for panel. However, in order to control the amounts of Sn and Mg (e.g., the above-described ratio of the number of atoms, or the ratio of the number of atoms to O) in the surface oxide film as in the present invention, it is preferred that a series of treatment processes of performing all of the alkali degreasing at a pH of 10 or more, the acid cleaning with a liquid containing sulfuric acid at a pH of 2 or less, the desmutting treatment with a liquid containing nitric acid at a pH of 2 or less, and the surface treatment for corrosion protection in this order is taken to decrease Sn or Mg having been concentrated in the surface oxide film by the heat treatment.

In order to control the amounts of Sn and Mg (e.g., the above-described ratio of the number of atoms, or the ratio of the number of atoms to O) in the surface oxide film, the oxide film or oxide film surface causing the interfacial peeling, in which Sn or Mg has been concentrated, is once removed by the above-described alkali degreasing treatment or the above-described acid cleaning with sulfuric acid. However, in the 6000 series aluminum alloy material containing Sn, by performing all of not only the removal of the oxide film but also the above-described series of treatment processes, the diffusion amount and content in the surface oxide film are simply regulated through a combination of the series of treatments, thereby enabling the ratio of the number of atoms of Sn or Mg or the ratio of the number of atoms to O to be set to the desired value. Although it is possible to supply Sn into the oxide film from the outside through surface treatment or the like, the use of Sn originally contained in the matrix is simple and rational.

Since Mg is highly inevitably concentrated in the surface oxide film, the removal of Mg or Mg oxide from the surface oxide film is mainly conducted for controlling Mg or Mg oxide in the surface oxide film. Therefore, it is preferred to remove Mg in the surface oxide film by a process such as the above-described series of surface treatments, etc.

The desmutting treatment is performed for the purpose of removing a black deposit (smut: resulting from deposition of impurities, such as Si, Mg, Fe, Cu, etc., or alloy components on aluminum) on the surface, which is generated during etching the aluminum alloy material by means of the above-described alkali degreasing. As for this smut removal, when non-oxidizing sulfuric acid is used, its reaction is slow so that the smut cannot be thoroughly removed, and it is preferred to perform the smut removal in dipping in an about 30% acidic aqueous solution of oxidizing nitric acid. When nitric acid is used, the amounts of Sn and Mg (e.g., the above-described ratio of the number of atoms, or the ratio of the number of atoms to O) in the surface oxide film can also be controlled by this desmutting treatment through a combination of the above-describe series of treatments.

As for the aqueous solution of the surface treatment for corrosion protection, the treatment is performed using an acid (inclusive of a mixed acid having two or more kinds of acids mixed therein) or alkali solution containing Si, Zr, Ti, Hf, V, Nb, Ta, Cr, Mo, and W in a form of ions or salts singly or in combination. In such surface treatment for corrosion protection, though the treatment conditions vary depending on the liquid composition or concentration, when the treatment is performed at a treatment temperature (liquid temperature) of 10 to 90° C. for a treatment time (dipping time) in a range of 1 to 200 seconds or 2 to 200 seconds, the amounts of Sn and Mg (e.g., the above-described ratio of the number of atoms, or the ratio of the number of atoms to O) in the surface oxide film can also be controlled by the surface treatment for corrosion protection through a combination of the series of treatments.

### (Surface Oxide Film)

In the present invention, each of the Sn content and Mg content in the oxide film (aluminum oxide film) formed on the surface of the foregoing 6000 series aluminum alloy material is specified for the purpose of improving the bonding durability. The oxide film itself in the present invention is a usual oxide film which is produced by the heat treatment on tempering to be performed inevitably in the above-described manufacturing process of the aluminum alloy material and naturally formed after the subsequent acid cleaning or surface treatment. In other words, it is not necessary to produce the oxide film by force or specifically by performing a special process of electrolysis, such as anodic oxidation, etc.

In the present invention, a ratio (Sn/Mg) of the number of atoms of Sn to that of Mg in the surface oxide film through semi-quantitative analysis of the oxide film formed on the surface of the 6000 series aluminum alloy material by X-ray photoelectron spectroscopy is set to a range of 0.001 to 3 on average, and a ratio {(Sn+Mg)/O} of the total number of atoms of Sn and Mg to the number of atoms of oxygen is set to a range of 0.001 to 0.2 on average.

The oxide film specified in the present invention is not always necessary to exist on the entire surface of the 6000 series alloy material surface but has only to exist on the surface on which at least the bonding agent is applied (coated) or partially exists. For example, so far as a sheet is concerned, the oxide film satisfying the requirements in the present invention has only to exist on one surface on which at least the bonding agent is applied (coated) or partially exists. The both surfaces of the sheet are not always an oxide film satisfying the requirements in the present invention.

As described previously, the existing state of Sn and Mg in the surface oxide film varies with a thickness direction of the surface oxide film, and for the bonding durability in the case of using the bonding agent, the existing state of Sn and Mg in the surface oxide film in an extremely shallow portion, such as an outermost surface or surface layer part of the surface oxide film coming into contact with the bonding agent, etc., is more relevant than that in a deep portion of the surface oxide film. In consequence, the present invention specifies the existing state of Sn and Mg in the surface oxide film in an extremely shallow portion, such as an outermost surface or surface layer part of the surface oxide film coming into contact with the bonding agent, etc.

### (XPS)

The X-ray photoelectron spectroscopy that is adopted in the present invention is also commonly named “XPS” and as well-known, is an analysis method in which a surface of a sample (oxide film) is irradiated with X-rays, and released photoelectrons are detected, thereby identifying an element on the surface of the sample (oxide film) or a chemical bonding state thereof. Then, as for the depth to be analyzed, an extremely shallow region to an extent of about several nm can be detected, and hence, it is also known that the XPS is suitable for extreme surface analysis.

The outermost surface or surface layer part of the surface oxide film, or the like is a measuring object by XPS, but a deep region of the surface oxide film, the boundary with the matrix aluminum alloy, or the like is outside the measuring object or unmeasurable. Therefore, in view of the fact that no disturbance due to the existing state of Sn and Mg in such a region is present, the XPS is suitable as extreme surface analysis of the surface oxide film as in the present invention.

In addition, as is well-known, the semi-quantitative analysis means a quantitative analysis not using a standard sample, and high analysis precision would not be expected as compared with a quantitative analysis using a standard sample. However, the semi-quantitative analysis is suitable for quantitation of the above-described ratio of the number of atoms specified in the present invention by the XPS from the standpoints of simplification and reproducibility of the measurement.

In the present invention, using the semi-quantitative analysis by the X-ray photoelectron spectroscopy capable of analyzing the existing state of Sn and Mg in the surface oxide film in such an extremely shallow portion, the ratio (Sn/Mg) of the number of atoms of Sn to that of Mg in the surface oxide film, or the ratio {(Sn+Mg)/O} of the total number of atoms of Sn and Mg to the number of atoms of oxygen, which significantly influences the bonding durability of a bonding agent, is specified.

When the outermost surface of the surface oxide film of the aluminum alloy material is subjected to the semi-quantitative analysis by the X-ray photoelectron spectroscopy, as spectra of the X-ray photoelectron spectroscopy, as is known, peaks having high relative intensity appear in peak names at Sn3d for Sn, Mg2p for Mg, and O1s for O (oxygen), respectively, and these three kinds of peak height (intensity) are each measured, whereby the ratio of each number of atoms can be determined.

The surface oxide film or aluminum alloy material that is a measuring object of the semi-quantitative analysis by the X-ray photoelectron spectroscopy is measured after its surface is cleaned with a cleaning liquid not containing elements working as a disturbance, such as Sn, Mg, etc., without being accompanied with etching. Taking also scattering of the oxide film composition into consideration, the measurement is performed in optional several places of the aluminum alloy material, for example, five places provided at appropriate intervals, and the resulting data are averaged.

(Ratio in Number of Atoms of Sn to that of Mg in Surface Oxide Film)

In the present invention, when the semi-quantitative analysis is performed by the X-ray photoelectron spectroscopy, the ratio (Sn/Mg) of the number of atoms of Sn to that of Mg in the surface oxide film is set to a range of 0.001 to 3 on average.

Here, the ratio (Sn/Mg) of the number of atoms of Sn to that of Mg indicates a bonding state of Sn and Mg in the surface oxide film, namely a state ratio of Sn to Mg (electron orbital states d1, S1, etc. in atoms of Sn and Mg) presumed from the chemical bond analysis results by X-ray photoelectron spectroscopy. The unit of the number of atoms of Sn or Mg is atm % but the ratio (Sn/Mg) is not a ratio to all of atoms existing on the surface. The ratio (Sn/Mg) that is a ratio of the number of atoms of Sn to the number of atoms of Mg (ratio in the number of atoms or atomic ratio) is a dimensionless number (no unit).

When the ratio (Sn/Mg) of the number of atoms of Sn to that of Mg in an extremely outer surface to an extent of about several nm in depth of the surface oxide film is set to a range of 0.001 to 3, an appropriate amount of Sn is contained in the extremely outer surface to an extent of about several nm in depth of the surface oxide film, and stability against degradation factors of the oxide film, such as water, oxygen, a chloride ion, etc., increases. That is, the bonding durability is improved by suppression of hydration on an interface between the applied bonding agent and the surface oxide film and suppression of elution of the base material.

In addition, when the ratio (Sn/Mg) of the number of atoms of Sn to that of Mg in an extremely outer surface to an extent of about several nm in depth of the surface oxide film is set to a range of 0.001 to 3 on average, concentration of Mg in the extremely outer surface to an extent of about several nm in depth of the surface oxide film is suppressed. Thanks to this feature, a weak boundary layer on a bonding interface with the bonding agent to be generated due to concentrated Mg is suppressed, and deterioration of the initial bonding durability and even in the degradation environment in which water, oxygen, a chloride ion, or the like permeates, the deterioration of the bonding durability to be caused due to hydration on the interface with the bonding agent or dissolution of the base material can be suppressed.

On the other hand, when the ratio (Sn/Mg) of the number of atoms of Sn to that of Mg is less than 0.01 on average, in the extremely outer surface to an extent of about several nm in depth of the surface oxide film, the proportion of Sn is too low, or the proportion of Mg is too high, so that the above-described improving effect of bonding durability vanishes. Conversely, the ratio (Sn/Mg) of the number of atoms of Sn to that of Mg is more than 3, selective dissolution of Sn has preference to the suppression effect of interfacial hydration, and the improving effect of bonding durability is saturated and then becomes deteriorated. In addition, when the ratio (Sn/Mg) of the number of atoms of Sn to that of Mg is more than 3 on average, it is also difficult to manufacture (control) a sheet having a surface oxide film which not only the Sn amount in the oxide film is increased, but also the Mg amount is suppressed.

In consequence, the ratio (Sn/Mg) of the number of atoms of Sn to that of Mg in an extremely outer surface to an extent of about several nm in depth of the surface oxide film is set to a range of 0.001 to 3 on average, and preferably a range of 0.02 to 1.5 on average.

### (Ratio of Total Number of Atoms of Sn and Mg to Number of Atoms of Oxygen in Surface Oxide Film)

Furthermore, in the present invention, on semi-quantitative analysis by X-ray photoelectron spectroscopy, the ratio {(Sn+Mg)/O} of the total number of atoms of Sn and Mg to the number of atoms of oxygen in the surface oxide film is set to a range of 0.001 to 0.2 on average. This indicates a bonding state of Sn and Mg with oxygen in the surface oxide film, namely bonding states of Mg—O, Sn—O, and Al—O, in other words, indicates the amount of Sn and Mg oxides.

This ratio {(Sn+Mg)/O} of the total number of atoms of Sn and Mg to the number of atoms of oxygen is also a ratio in the number of atoms or atomic ratio, and hence, it is a dimensionless number (no unit).

In the surface oxide film, Al atoms are also existed. Actually, when the Al, Sn, and Mg atoms take oxide forms of appropriate amounts, the bonding durability is first obtained. That is, when the amounts of the Sn and Mg oxides in the extremely outer surface to an extent of about several nm in depth of the surface oxide film are controlled to the above-described ranges, the Al, Sn, and Mg atoms take oxide forms of appropriate amounts, whereby the bonding durability is improved.

When the ratio {(Sn+Mg)/O} of the total number of atoms of Sn and Mg to the number of atoms of oxygen in the surface oxide film is less than 0.001 on average, the proportion of the Sn-based oxides and Mg-based oxide is too low, and the proportion of the Al oxide is too high, so that the bonding durability of the surface oxide film itself is deteriorated. On the other hand, when the ratio {(Sn+Mg)/O} of the total number of atoms of Sn and Mg to the number of atoms of oxygen in the surface oxide film is more than 0.2 on average, the proportion of the Sn and Mg based oxides is too high, so that joining of the Al base material (matrix) to the bonding agent becomes difficult, and the bonding durability is deteriorated.

When the proportion of the Mg oxide film is too high, it reacts with water of the oxide film to cause hydrolysis, whereby the pH on the interface is made alkaline to deteriorate the bonding durability. However, actually, the proportion of the Mg oxide cannot be made zero. In addition, when the proportion of the Sn oxide is too low, the stabilizing effect against the above-described degradation factors, such as repellence of a chloride ion, oxygen, or water, cannot be thoroughly exhibited. On the other hand, when the proportion of the Sn oxide is too high, it is difficult to reveal properties of the sheet by tempering, and not only the mechanical properties or formability is deteriorated, but also such becomes a cause to contain solid Sn, and therefore, this Sn reacts with water or oxygen to cause deterioration of the bonding durability.

In consequence, the ratio {(Sn+Mg)/O} of the total number of atoms of Sn and Mg to the number of atoms of oxygen in an extreme surface to an extent of about several nm in depth of the surface oxide film is set to a range of 0.001 to 0.2 on average, and preferably to a range of 0.04 to 0.17 on average.

### Control of Sn and Mg in Surface Oxide Film

As a method of containing Sn or an Sn oxide in the above-prescribed amount in the surface oxide film, for example, by not only diffusing Sn in the matrix alloy in the surface oxide film by heat treatment but also removing excessive Sn from the surface oxide film through the above-described series of surface treatments, the diffusion amount and content of Sn in the surface oxide film can be simply adjusted to control to the desired Sn content through a combination of the foregoing treatments. Although it is possible to feed Sn into the oxide film from the outside through surface treatment or the like, it is simple and rational to utilize Sn originally contained in the matrix.

Since Mg is inevitably concentrated in the surface oxide film, on controlling Mg or an Mg oxide in the surface oxide film, the removal of Mg or an Mg oxide from the surface oxide film is mainly subjective. Therefore, it is preferred to remove Mg in the surface oxide film by a process, such as the above-described series of treatments, etc.

### Film Thickness of Surface Oxide Film

A thickness of the oxide film is preferably 1 to 30 nm. In order to control the thickness of the oxide film to less than 1 nm, excessive acid cleaning or the like becomes necessary, and thus, the productivity is inferior, and the practicability is liable to be deteriorated. On the other hand, when the thickness of the oxide film is more than 30 nm, the film amount becomes excessive, and asperities are liable to be produced on the surface. Then, when the asperities are produced on the surface of the oxide film, for example, on chemical conversion to be performed prior to a finish process in an automotive application, uneven chemical conversion is liable to occur, resulting in deterioration of chemical conversion properties. The thickness of the oxide film is more preferably 3 nm or more and less than 20 nm from the viewpoints of chemical conversion properties, productivity and so on.

### Joining of Aluminum Alloy Material

The aluminum ally material in the present invention has a bonding layer on the surface of the surface oxide film having the above-described specified composition, and the aluminum alloy material is, as an automotive member, etc., joined to other member, for example, an aluminum alloy material of the same kind or a steel material, such as a steel sheet of a different kind, etc., a plastic material, a ceramic material, or the like. In addition, the aluminum alloy materials in the present invention may also be joined to each other through a bonding layer in such a manner that the respective surface oxide films face each other. The composition of the surface oxide film in the present invention may be in a state after the manufacture of the aluminum alloy material. However, taking into consideration any change of the oxide film in the case where a leave time at room temperature of from forming as an automotive member after the manufacture of the sheet until joining the members of the same kinds to each other or the member to other member becomes long, it is most preferred that the state on joining with this bonding agent satisfies the above-prescribed specified composition.

Although the formation of the bonding layer is a process of forming a bonding layer made of a bonding agent on the surface of the surface oxide film, the formation method is not particularly limited. For example, there is exemplified a method in which the bonding agent is sprayed or applied onto the surface oxide film 2 after being dissolved in a solvent to form a solution in the case where the bonding agent is a solid, or directly in the case where the bonding agent is liquid. For the bonding agent, resin bonding agents which are used for general purpose or commercially available as a bonding agent of automotive member can be used, and examples thereof include thermosetting epoxy resins, acrylic resins, urethane resins, and the like. In addition, though the thickness of the bonding agent is not particularly limited, it is preferably 10 to 500 μm, and more preferably 50 to 400 μm.

The present invention is hereunder more specifically described by reference to Examples; however, the present invention is essentially not limited by the following Examples but can be carried out with appropriate modifications within the scope that can comply with the gist described above and below, and these are all included within the technical scope of the present invention.

### Examples

Next, the Examples of the present invention are described. Sn-containing 6000 series aluminum alloy sheets having a different ratio (Sn/Mg) of the number of atoms of Sn to that of Mg in a surface oxide film, or a different ratio {(Sn+Mg)/O} of the total number of atoms of Sn and Mg to the number of atoms of oxygen, from each other were individually prepared and evaluated for each of bonding durability, BH response, and hem bendability.

More specifically, a Sn-containing 6000 series aluminum alloy cold rolled sheet having a composition shown in Table 1 was manufactured, and after subjecting this cold rolled sheet to tempering treatment, the resulting sheet was individually prepared while changing the surface treatment conditions as shown in Table 2. In the expression of the content of each of the elements in Table 1, the expression as a blank for numerical value in each element indicates that the content is below the detection limit and is 0% meaning that such an element is not contained.

### (Manufacturing Conditions of Sheet)

The above-described 6000 series aluminum alloy sheet was manufactured under manufacturing conditions common in every example using an aluminum alloy slab having each composition shown in Table 1. That is, melting was performed by the DC casting method while making an average cooling rate at casting from a liquidus temperature to a solidus temperature large as 50° C./min or more, the slab was subjected to soaking treatment at 540° C. for 6 hours, and then, hot rough rolling was commenced at that temperature. Subsequently, the resultant was hot rolled to have a thickness of 3.3 mm by finish rolling, thereby preparing a hot rolled sheet. This hot rolled sheet was subjected to rough annealing at 500° C. for one minute and then to cold rolling at a processing rate of 70% without process annealing on the way of cold-rolling pass, thereby preparing a cold rolled sheet (coil) having a thickness of 1.0 mm.

Furthermore, this every cold rolled sheet (coil) was rewound by continuous heat treatment equipment and then continuously subjected to tempering treatment (T4) while winding. More specifically, solution treatment was performed at an average heating rate of 10° C./sec until 500° C.; after reaching a target temperature of 560° C., the resultant was held for 10 seconds; and thereafter, cooling was performed to room temperature by water quenching at an average cooling rate of 100° C./sec. After cooling, pre-aging treatment of holding at 100° C. for 5 hours was performed (after holding, gradually cooled at a cooling rate of 0.6° C./hr). After performing the pre-aging treatment, various surface treatments were performed.

### (Surface Treatment)

In each of Invention Examples of Table 2, with respect to each of sheets (sheet piece) commonly collected from the coil after the above-described pre-aging, alkali degreasing at a pH of 10 or more, acid cleaning with a liquid containing sulfuric acid at a pH of 2 or less, desmutting treatment with a liquid containing nitric acid at a pH of 2 or less, and the above-described surface treatment for corrosion protection were performed in this order within the above-described condition ranges. In addition, varying the liquid temperature and the dipping time in each process, a ratio (Sn/Mg) of the number of atoms of Sn to that of Mg in the surface oxide film and a ratio {(Sn+Mg)/O} of the total number of atoms of Sn and Mg to the number of atoms of oxygen were adjusted variously. As an aqueous solution for the above-described surface treatments, an acid solution containing 1 wt % of each of Zr and Ti ions was used commonly in the respective Examples.

In Table 2, for comparison, the cases of Comparative Examples 16, 17, and 18 in which the aluminum alloy sheet having a composition of Alloy No. 1 in Table 1, which was the same as the case of Invention Example 1, was used, but the surface treatment conditions were changed, were prepared.

In Comparative Example 16, though such a series of treatments was performed, but the desmutting treatment was not performed, and the acid cleaning was performed under the treatment condition such that the Sn content in the acid oxide film was 0.

In Comparative Example 17, such a series of treatments was not performed at all.

In Comparative Example 18, only the alkali degreasing was performed.

In Table 2, as Comparative Examples 19 and 20, as shown in Alloy Nos. 14 and 15 in Table 1, even in the case where the aluminum alloy sheet did not contain Sn, the same evaluations were performed in accordance with the same manufacturing method or surface treatment conditions as in the Invention Examples.

After these respective surface treatments, commonly in the respective examples, the aluminum alloy sheet was rinsed with water within 5 minutes and then dried within 5 minutes after the water rinsing, thereby preparing an aluminum alloy sheet in which a surface oxide film having a thickness of less than 20 nm was formed on the both surfaces of the sheet. The resulting aluminum alloy sheet was provided for a test material. In only Comparative Example 17 in Table 2, in which the above-described series of treatments was not performed, each sheet (sheet piece) collected from the coil after the above-described pre-aging was rinsed with water and dried in the same manner, and the resulting sheet was provided for a test material.

Then, taking the matter that the manufactured sheet was aged at room temperature until having being joined with a bonding agent into consideration, a test piece having a size of 100 mm in length and 25 mm in width was collected from each test material after allowing the surface-treated test material to stand at room temperature for 30 days (room-temperature aging). Then, on semi-quantitative analysis of the oxide film formed on the surface of this test piece by X-ray photoelectron spectroscopy in the same way as described above, the ratio (Sn/Mg) of the number of atoms of Sn to that of Mg in the surface oxide film and the ratio {(Sn+Mg)/O} of the total number of atoms of Sn and Mg to the number of atoms of oxygen were calculated as average values measured at optional five places of the test piece. The results are shown in Table 2.

The semi-quantitative analysis conditions by the X-ray photoelectron spectroscopy were as follows.

μ-XPS analysis apparatus: Quantera SXM, manufactured by Physical Electronics

X-Ray source: Monochromatic AlKα-ray

Beam diameter: 20 μm

Photoelectron take-off angle: 45°

The resolution Δz of depth analysis of XPS follows JIS K0146.

### (Bonding Durability Evaluation)

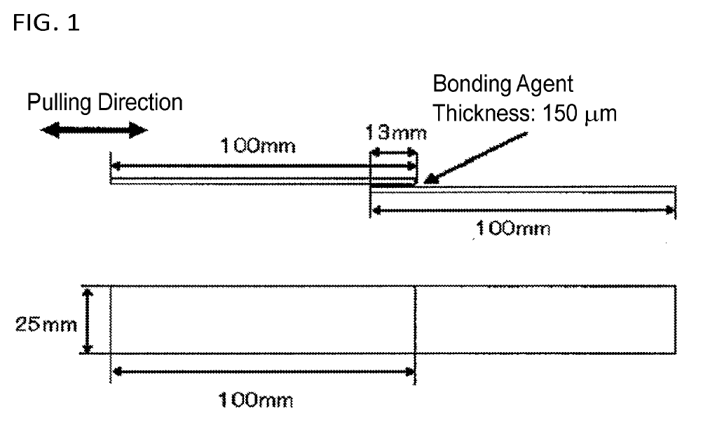

One of respective ends of two sheets of the test materials (25 mm in width) having the same construction was overlaid on another to stick thereto with the use of a thermosetting epoxy resin-based bonding agent while having a lap length of 13 mm (a bonding area: 25 mm×13 mm), as shown in FIG. 1. The bonding agent as used herein was a thermosetting epoxy resin-based bonding agent (bisphenol A type epoxy resin content: 40 to 50%). Then, adjustment was made by adding a trace of glass beads (grain size: 150 μm) to the bonding agent such that a thickness of the bonding layer was 150 μm. The sample was dried at room temperature for 30 minutes after overlapped and subsequently heated at 170° C. for 20 minutes, thereby carrying out a thermal hardening process. Thereafter, the sample was allowed to stand at room temperature for 24 hours, thereby preparing a bonding test body.

The prepared bonding test body was held in a high-temperature and humid environment of 50° C. and a relative humidity of 95% for 30 days, followed by pulling at a rate of 50 mm/min using a tensile tester, thereby evaluating a cohesion failure ratio of the bonding agent of a bonded portion. The cohesion failure ratio was determined in accordance with the following expression. In the following expression, the left side of the bonding test body after pulling in FIG. 1 is designated as “test piece A”, and the right side in FIG. 1 is designated as “test piece B”. Three test bodies were prepared under each test conditions, and an average value of the three test bodies was adopted as the cohesion failure ratio.

Cohesion failure ratio (%)=100−[{(Interfacial peeling area of test piece A)/(Bonding area of test piece A)}×100]−[{(Interfacial peeling area of test piece B)/(Bonding area of test piece B)}×100]

The evaluation was made in accordance with the following criteria. Namely, the cohesion failure ratio of less than 60% was expressed as poor “X”; the cohesion failure ratio of 60% or more and less than 80% was expressed as somewhat poor “Δ”; the cohesion failure ratio of 80% or more and less than 90% was expressed as good “◯”; and the cohesion failure ratio of 90% or more was expressed as excellent “ [symbol] ”. In those criteria, in joining using a bonding agent of automotive panel, “ [symbol] ” and “◯” are acceptable, and “Δ” and “X” are unacceptable.

### (BH Response)

As mechanical properties of each test sheet which after the above-described surface treatment, had been allowed to stand at room temperature for 30 days (room-temperature aging), a 0.2% yield strength (As yield strength) was determined by a tensile test. Furthermore, in each of those test sheets, 0.2% yield strength (yield strength after BH) of the test sheet after aging at room temperature for 30 days and then subjecting it to an artificial age hardening treatment at 185° C. for 20 minutes (i.e. after the BH) was obtained by a tensile test. BH responses of each test sheet were evaluated from the difference (increased amount of yield strength) between those 0.2% yield strengths.

As for the BH response after room-temperature aging for 30 days, it is preferred that the As yield strength at press forming (before baking) into an automotive outer panel is 110 MPa or less. Furthermore, it is preferred that the artificial aging hardening amount (BH response) under the above-described baking conditions is 100 MPa or more in terms of a difference from the above-described As yield strength. In consequence, a sheet having such As yield strength and BH response was evaluated as “◯”, and a sheet in which the As yield strength is more than 110 MPa, or the BH response is less than 100 MPa in terms of a difference from the As yield strength was evaluated as “X”.

### (Tensile Test)

As the tensile test, each No. 5 test specimen (having a size of 25 mm×50 mm as GL×Thickness) in accordance with JIS Z 2201 was collected from each test sheet, followed by subjecting to a tensile test at room temperature. In this case, a tensile direction of the test specimen was a direction perpendicular to a rolling direction. A tensile rate was 5 mm/min until reaching 0.2% yield strength, and was 20 mm/min after reaching the yield strength. The number N of the measurement of mechanical properties was set to 5, and average value was calculated for each of the properties. Prestrain of 2% simulating press forming of a sheet was given to the test specimen for the measurement of yield strength after the BH by the tensile tester, and the BH treatment was then performed.

### (Hem Bendability)

As for the hem bendability, a strip specimen having a width of 30 mm was used as each test sheet. After performing 90° bending working of inner bending R=1.0 mm by down flange, an inner having a thickness of 1.0 mm was interposed. Preliminary hem working that further bends the bent part inside to an angle of about 130° and flat hem working that bends 180° to closely contact the edge with the inner were performed.

Surface state such as generation of surface roughness, fine cracking or large cracking of the bent part (hemming part) of the flat hem was visually observed and was visually evaluated by the following standards. In the following criteria, a range of 0 to 1 was evaluated acceptable and designated as “◯”. In addition, a range of 2 to 5 was evaluated unacceptable and designated as “X”:

0: No cracking and surface roughness

1: Slight surface roughness

2: Deep surface roughness

3: Fine surface cracking

4: Linearly continuous surface cracking

5: Breakage

Invention Examples 1 to 15 shown in Table 2 were manufactured within the preferred component composition ranges and the above-described preferred condition ranges. For this reason, in these aluminum alloy sheets, the ratio (Sn/Mg) of the number of atoms of Sn to that of Mg in the surface oxide film formed on the surface thereof is in a range of 0.001 to 3 on average, and the ratio {(Sn+Mg)/O} of the total number of atoms of Sn and Mg to the number of atoms of oxygen is in a range of 0.001 to 0.2 on average. For this reason, these aluminum alloy sheets satisfy the bonding strength with a bonding agent and excellent in bonding durability, as required for automotive panels. In addition, these aluminum alloy sheets are excellent in the BH response even after the room-temperature aging. In addition, even after the room temperature-aging, the As yield strength is relatively low, and therefore, these aluminum alloy sheets are excellent in press formability into automotive panels or the like and also excellent in hem workability. In consequence, these aluminum alloy sheets satisfy the required properties as an automotive panel structure.

On the other hand, as shown in Table 2, in Comparative Examples 16, 17, and 18, in view of the fact that the surface treatment is not applied or the surface treatment conditions are inappropriate, the ratio (Sn/Mg) of the number of atoms of Sn to that of Mg in the surface oxide film formed on the surface thereof, or the ratio {(Sn+Mg)/O} of the total number of atoms of Sn and Mg to the number of atoms of oxygen, falls outside the scope specified in the present invention. As a result, these respective Comparative Examples are remarkably inferior in the bonding durability to the above-described Invention Examples, and in the case of using a bonding agent, these cases of the Comparative Examples cannot be used for automotive panels.

In addition, in Comparative Examples 19 and 20, the manufacture method or surface treatment conditions as in the Invention Examples were adopted; however, as in Alloy Nos. 14 and 15 in Table 1, the aluminum alloy sheet does not contain Sn, and the ratio (Sn/Mg) of the number of atoms of Sn to that of Mg in the surface oxide film formed on the surface thereof is 0. In addition, the ratio {(Sn+Mg)/O} of the total number of atoms of Sn and Mg to the number of atoms of oxygen is also O. For this reason, though these cases of the Comparative Examples satisfy the BH response or hem bendability as required for automotive panels, these are inferior in bonding durability and not suitable for automotive panels to be joined using a bonding agent.

From the foregoing results of the Examples, in the case of using a bonding agent for joining to other member, any meanings of the action and effect against the bonding durability regarding the existing state of Sn and Mg in an extremely shallow portion, such as an outermost surface or surface layer part of the surface oxide film coming into contact with the bonding agent, as specified in the present invention, are proven.

TABLE 1

| Alloy | Chemical components of aluminum alloy sheet (mass %, balance: Al) | | | | | | | | | | | |
|---|---|---|---|---|---|---|---|---|---|---|---|---|
| No. | Mg | Si | Sn | Fe | Mn | Cr | Zr | V | Ti | Cu | Zn | Ag |
| 1 | 0.65 | 1.00 | 0.042 | | | | | | | | | |
| 2 | 0.53 | 0.96 | 0.031 | | | | | | | | | |
| 3 | 0.55 | 0.90 | 0.038 | 0.20 | 0.10 | | | | | | | |
| 4 | 0.34 | 1.51 | 0.076 | 0.28 | | 0.21 | | | | | | |
| 5 | 1.47 | 0.43 | 0.110 | 0.23 | | | 0.20 | | | | | |
| 6 | 0.55 | 0.79 | 0.005 | 0.20 | | | | 0.19 | | | | |
| 7 | 0.55 | 0.90 | 0.198 | 0.20 | 0.10 | | | | 0.01 | | | |
| 8 | 0.71 | 1.00 | 0.054 | 0.22 | | | | | 0.05 | | | |
| 9 | 0.55 | 0.90 | 0.053 | 0.52 | 0.10 | | | | 0.01 | 0.34 | | |
| 10 | 0.55 | 0.90 | 0.053 | 0.20 | 0.10 | | | | 0.01 | 0.80 | | |
| 11 | 0.55 | 0.90 | 0.053 | 0.20 | 0.62 | | | | 0.02 | | 0.05 | |
| 12 | 0.55 | 0.90 | 0.053 | 0.20 | 0.10 | | | | 0.02 | | 0.60 | |
| 13 | 0.56 | 0.97 | 0.036 | 0.20 | 0.10 | | | | 0.02 | 0.15 | | 0.01 |
| 14 | 0.38 | 0.90 | | 0.20 | 0.10 | | | | 0.01 | | | |
| 15 | 0.63 | 1.00 | | | | | | | | | | |

TABLE 2

| | | | Al—Mg—Si alloy sheet | | | | | |
|---|---|---|---|---|---|---|---|---|
| | | | | Surface oxide film | | | | |
| | | | | Ratio (Sn/Mn) in | Ratio {(Sn + Mg)/O} of the | | | |
| | | Alloy | | the number of | total number of atoms of Sn | | Properties of sheet | |
| | | No. in | Surface treatment | atoms of Sn and | and Mg to the number of | Bonding | BH | Hem |
| Division | No. | Table 1 | conditions | Mg in average | atoms of oxygen in average | durability | response | bendability |
| Invention | 1 | 1 | Alkali degreasing | 0.024 | 0.045 | [symbol] | ◯ | ◯ |
| Example | 2 | 1 | [symbol] Acid cleaning | 0.003 | 0.064 | ◯ | ◯ | ◯ |
| | 3 | 1 | [symbol] Desmutting treatment | 2.667 | 0.064 | ◯ | ◯ | ◯ |
| | 4 | 2 | [symbol] Surface treatment | 0.159 | 0.105 | [symbol] | ◯ | ◯ |
| | 5 | 3 | | 0.024 | 0.045 | ◯ | ◯ | ◯ |
| | 6 | 4 | | 0.161 | 0.037 | [symbol] | ◯ | ◯ |
| | 7 | 5 | | 0.821 | 0.054 | [symbol] | ◯ | ◯ |
| | 8 | 6 | | 0.944 | 0.163 | ◯ | ◯ | ◯ |
| | 9 | 7 | | 1.419 | 0.116 | ◯ | ◯ | ◯ |
| | 10 | 8 | | 1.153 | 0.183 | ◯ | ◯ | ◯ |
| | 11 | 9 | | 0.625 | 0.149 | ◯ | ◯ | ◯ |
| | 12 | 10 | | 0.547 | 0.172 | ◯ | ◯ | ◯ |
| | 13 | 11 | | 0.129 | 0.188 | ◯ | ◯ | ◯ |
| | 14 | 12 | | 0.261 | 0.030 | [symbol] | ◯ | ◯ |
| | 15 | 13 | | 0.488 | 0.068 | [symbol] | ◯ | ◯ |
| Comparative | 16 | 1 | Alkali degreasing | 3.200 | 0.266 | X | ◯ | ◯ |
| Example | | | [symbol] Acid cleaning | | | | | |
| | | | [symbol] Surface treatment | | | | | |
| | 17 | 1 | No treatment | 3.750 | 0.040 | X | ◯ | ◯ |
| | 18 | 1 | Only alkali degreasing | 0.250 | 0.333 | Δ | ◯ | ◯ |
| | 19 | 14 | Alkali degreasing | 0.000 | 0.000 | X | ◯ | ◯ |
| | 20 | 15 | [symbol] Acid cleaning | 0.000 | 0.000 | X | ◯ | ◯ |
| | | | [symbol] Desmutting treatment | | | | | |
| | | | [symbol] Surface treatment | | | | | |

Although the present invention has been described in detail and by reference to the specific embodiments, it is apparent to one skilled in the art that various modifications or changes can be made without departing the spirit and scope of the present invention.

This application is based on Japanese Patent Application No. 2014-173279 filed on Aug. 27, 2014, the disclosure of which is incorporated herein by reference in its entity.

### INDUSTRIAL APPLICABILITY

In accordance with the present invention, it is possible to provide a 6000 series aluminum alloy material capable of being applied as an automotive member, such as automotive panels, etc., using a bonding agent for joining to the member, without impairing BH response after room-temperature aging and formability. As a result, application of 6000 series aluminum alloy sheets to automotive panels, particularly outer panels or the like, in which desirability on beautiful curved structure, character line, etc. is of a problem so that a bonding agent should be used, can be expanded.

1. An Al—Mg—Si aluminum alloy material, comprising Sn,
wherein a ratio of a number of Sn atoms to a number of Mg atoms in an oxide film formed on a surface of the aluminum alloy material is 0.001 to 3 on average and a ratio of a total number of atoms of Sn and Mg to a number of oxygen atoms is 0.001 to 0.2 on average, as determined by a semi-quantitative analysis of the oxide film by X-ray photoelectron spectroscopy.

2. The aluminum alloy material according to claim 1, comprising
a bonding layer on a surface of the oxide film.

3. A joined body, comprising
two or more aluminum alloy materials according to claim 1,
wherein the aluminum alloy materials are joined to each other through a bonding layer such that respective oxide films face each other.

4. An automotive member, comprising
the aluminum alloy material according to claim 2.

5. An automotive member, comprising
the joined body according to claim 3.
